(19) United States
(12) Patent Application Publication
(10) Pub. No.: US 2009/0039632 A1
(43) Pub. Date: Feb. 12, 2009

(54) STABILIZER

(76) Inventors: Seiji Sakada, Fukuoka (JP); Nagahiro Ogata, Fukuoka (JP); Hiroyuki Ootsuki, Fukuoka (JP); Makiko Tajima, Fukuoka (JP)

Correspondence Address: STERNE, KESSLER, GOLDSTEIN & FOX P.L.L.C., 1100 NEW YORK AVENUE, N.W., WASHINGTON, DC, 20005, US

(21) Appl. No.: 11/908,681

(22) PCT Filed: Jan. 17, 2006
(86) PCT No.: PCT/JP2006/300470

§ 371 Date: Nov. 28, 2007

(30) Foreign Application Priority Data
Mar. 14, 2005 (JP) 2005-072089

(51) Int. Cl. E02F 9/08; B60S 9/10

(52) U.S. Cl. 280/764.1

(57) ABSTRACT

A stabilizer installed on a work vehicle to hold the stability of a vehicle body in excavating operation and capable of preventing the ground-contact surface of a stabilizer pad from being inverted upward when the attitude of the stabilizer pad installed at the outer tip of the vehicle body is not stabilized. A balancer 25 is fitted to the end of the stabilizer pad 30. A downward moment always acts on the stabilizer pad 30 about a stabilizer pad pivot 26 (direction of solid arrow α in the figure) by the weight of the balancer 25. Thus, the stabilizer pad 30 can always keep its attitude with its ground-contact surface facing downward irrespective of the vertical rotation of a leg body 23.

### TECHNICAL FIELD

The present invention relates to a technique of a stabilizer (outrigger) installed on a work vehicle to hold a stability of the vehicle in excavating operation.

### BACKGROUND ART

There is a conventional work vehicle in which a front loader is mounted on a front portion of a tractor and a back hoe as a drilling device is mounted on a rear portion of the tractor. In this work vehicle, when excavation operation is carried out by the back hoe, stabilizers provided on both left and right sides of a machine casing of the back hoe and a bucket mounted on a tip end of a boom of the front loader are brought into contact with the ground, the vehicle body is lifted up by these members to push up the vehicle body to hold the stability of the vehicle body. Such stabilizers provided on the back hoe to hold the vehicle stability at the time of operation is known in patent document 1.

[Patent Document 1] Japanese Patent Application Laid-Open No. H7-268905

### DISCLOSURE OF THE INVENTION

### Problems and Object

An outer tip end of the vehicle body of the stabilizer is provided with a stabilizer pad which actually comes into contact with the ground when holding the stability of the vehicle body. The stabilizer and the stabilizer pad are connected to each other with a shaft as a fulcrum, and the stabilizer pad can rotate around the shaft with respect to the stabilizer. Here, the attitude of the stabilizer pad is independent from vertical turning motion of the stabilizer by operator's control. Thus, when the work vehicle carries out the excavation operation by means of the back hoe, if the stabilizer is vertically turned to bring the stabilizer pad into contact with the ground, the stabilizer pad is inversed and a ground-contact surface is oriented upward in some cases.

While the stabilizer pad comes into contact with the ground and the excavation operation is carried out by the back hoe, earth and sand are accumulated on an upper surface of the stabilizer pad which is in contact with the ground in some cases. Thus, when the stabilizer pad is turned upward to accommodate the stabilizer when the operation is completed, the earth and sand accumulated on the upper surface of the stabilizer pad fall on an operator. Moreover, when the stabilizer pad is brought into contact with the ground and a lift amount of the vehicle body is changed by the stabilizer, the stabilizer pad blunders against the earth and sand, the stabilizer pad is inversed and the ground-contact surface is oriented upward in some cases.

In an arm structure of the stabilizer, the existing box-like shape requires four plates, i.e., left and right side plates, a ceiling plate and a bottom plate, requiring long welding length, as a result, producing cost is increased. In the case of the box-shaped structure having equal cross section structures, in order to secure strength of the stabilizer and to improve portions having insufficient strength, it is also necessary to increase a cross section of a portion having sufficient strength. With this, quality is excessively enhanced locally and weight is also increased unnecessarily. Here, as a shape other than the box-shape, there is a square pipe structure, but with the square pipe, it is only possible to increase the pipe size to secure the strength of the stabilizer. In reality, since the number of kinds of pipe sizes is limited, it is difficult to secure the strength.

It is an object of the present invention to always stabilize an attitude of a stabilizer pad provided in a stabilizer irrespective of vertical turning motion of the stabilizer. It is another object of the invention to prevent earth and sand from accumulating on an upper surface of the stabilizer pad while the stabilizer pad is in contact with the ground to reduce a resistance between the stabilizer pad and earth and sand. It is another object of the invention to reduce the welding length of a stabilizer to reduce a producing cost, unnecessary strength is lowered so that increase in weight can be suppressed.

### Solution

Problems to be solved by the inventions are as described above, and means for solving the problems will be explained below.

That is, stabilizers disposed on both left and right sides of a work vehicle for stabilizing a vehicle body at the time of operation by stretching both the left and right sides, wherein each of the stabilizers comprises a leg body, a vertically moving cylinder for vertically turning the leg body, and a stabilizer pad which is pivotally supported by a tip end of the leg body for coming into contact with the ground, and wherein a balancer is provided on an outer side than a pivot of the stabilizer pad.

In the present invention, the balancer and the stabilizer pad are integrally formed together.

In the present invention, warps are formed on ends of both side surfaces of the stabilizer pad.

### EFFECT OF THE INVENTION

The present invention exhibits the following effects.

According to the present invention, the balancer is provided on the outer side than the pivot of the stabilizer pad. With this, even when the stabilizer is vertically turned, the ground-contact surface of the stabilizer pad can always face downward, the stabilizer pad is not inverted by the vertical turning motion of the stabilizer, the operability can be enhanced, and the stabilizer pad can be stabilized without staggering when the stabilizer pad is vertically moved.

Since the integral stabilizer pad is integrally formed, the stabilizer pad and the balancer are can be produced at the same time, it can be produced inexpensively and its structure can be simplified.

Since the warps are formed on ends of both side surfaces of the stabilizer pad, it is possible to prevent earth and sand from accumulating on the stabilizer pad while the stabilizer pad is in contact with the ground. That is, when the excavation operation is completed and the stabilizer is to be accommodated, it is possible to prevent earth and sand accumulated on the upper surface of the stabilizer pad from falling onto an operator.

The warps on the both ends are not easily caught by the ground surface, and when the stabilizer pad comes into contact with the ground and then a lift amount of the vehicle body is to be changed by the stabilizer, it is possible to prevent the stabilizer pad from blundering against the earth and sand and from being inverted, and to prevent the ground-contact surface from facing upward.

### BRIEF DESCRIPTION OF THE DRAWINGS

FIG. 1 is a side view showing an entire structure of a back hoe loader having a stabilizer of the present invention.

FIG. 2(a) is a side view in a state where the stabilizer is turned upward, and FIG. 2(b) is a side view in a state where the stabilizer is projected sideway.

FIG. 3 is a perspective view showing a shape of a stabilizer pad of the invention.

FIG. 4 is a perspective view showing a shape of a stabilizer pad according to another embodiment.

FIG. 5 is a side view of the stabilizer pad of the same.

FIG. 6 is a perspective view showing a leg body structure of the stabilizer.

FIG. 7(a) is a side view of the stabilizer and FIG. 7(b) is a sectional view of the stabilizer.

### EXPLANATION OF REFERENCE NUMERALS

10. stabilizer
23. leg body
25. balancer
30. stabilizer pad

### BEST MODE FOR CARRYING OUT THE INVENTION

Next, embodiments of the present invention will be explained.

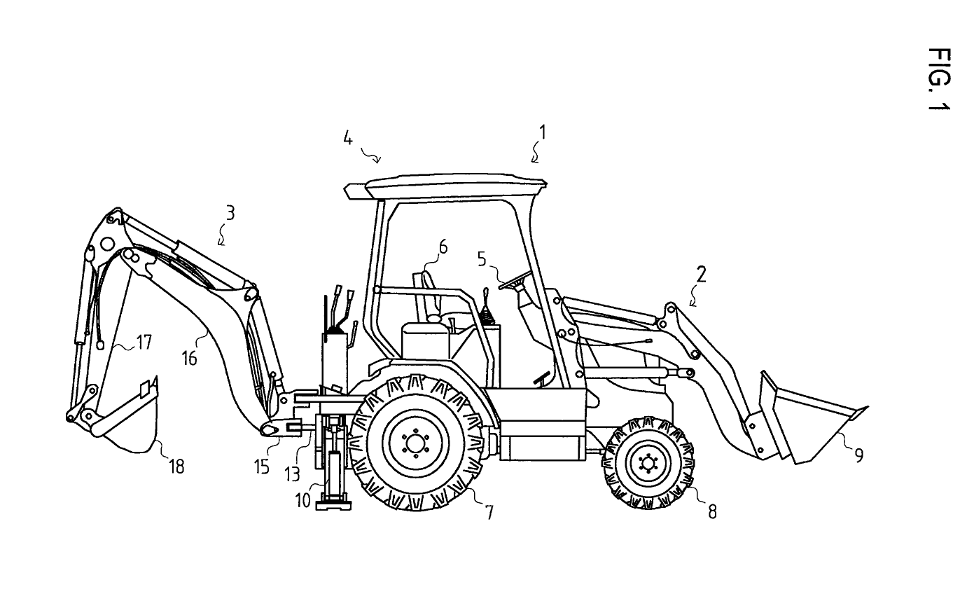

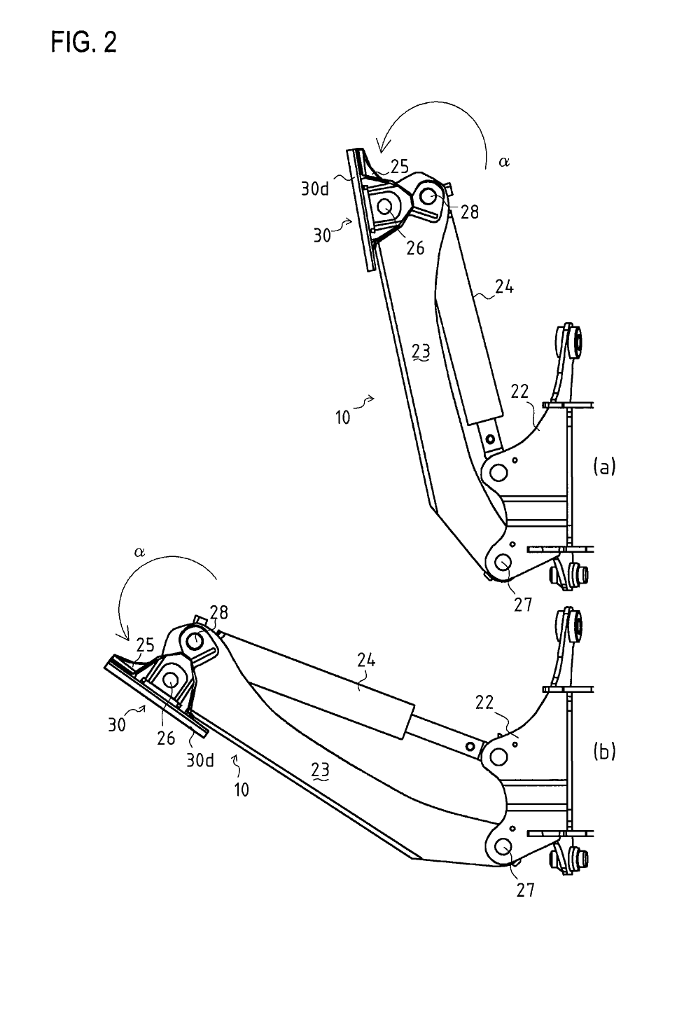

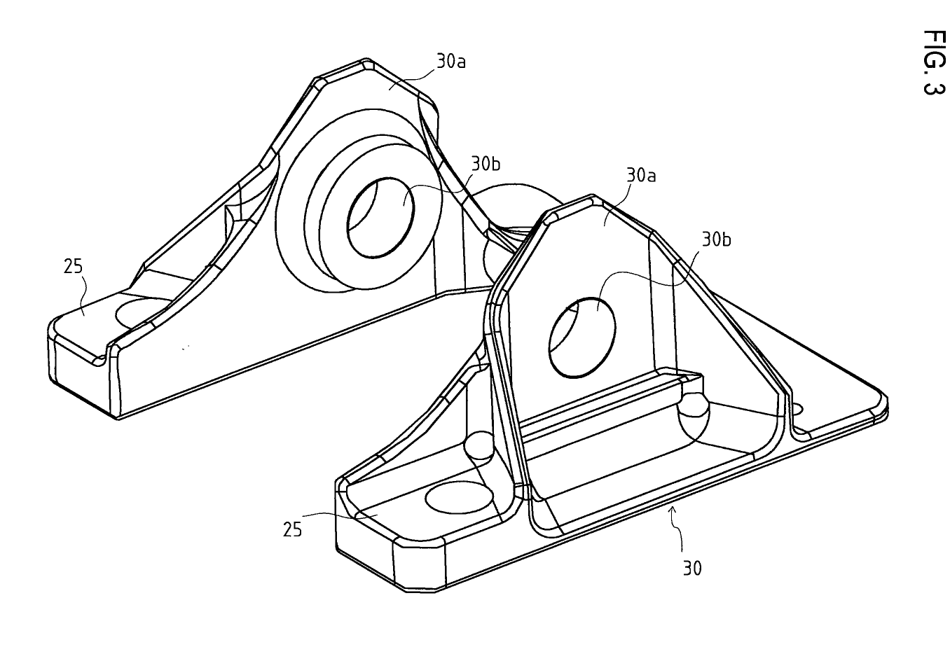

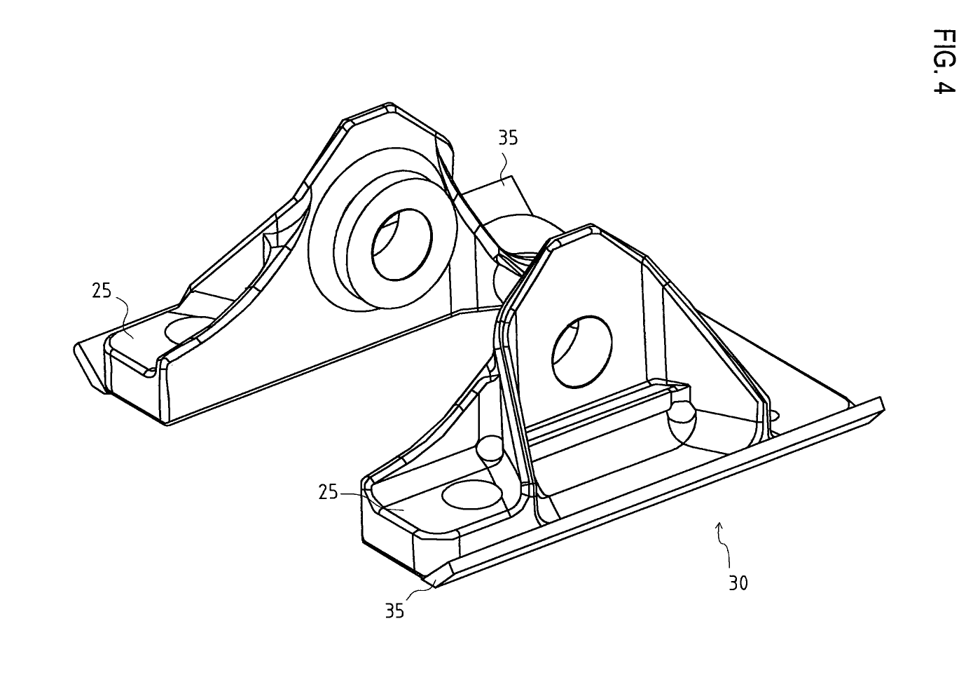

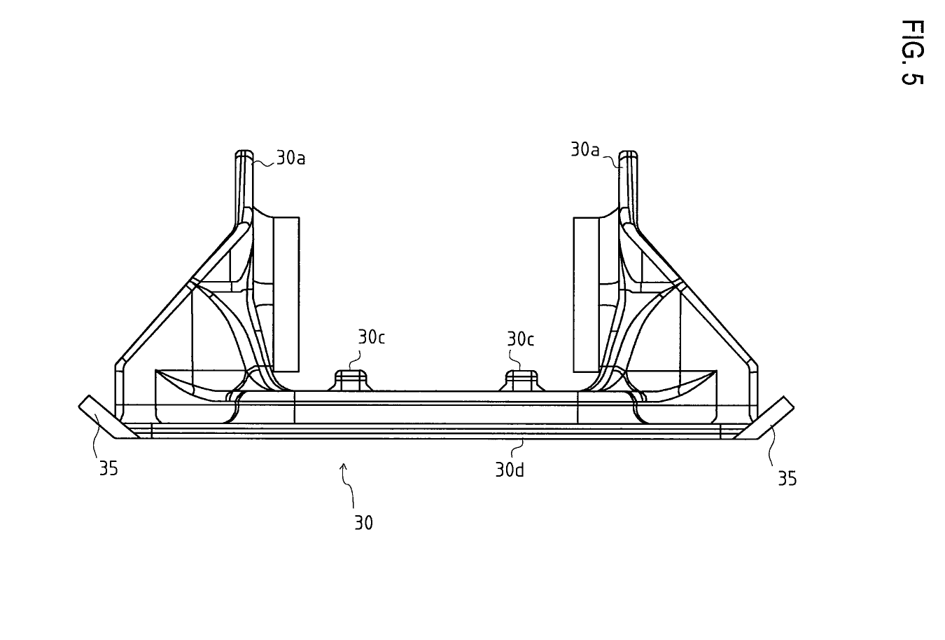

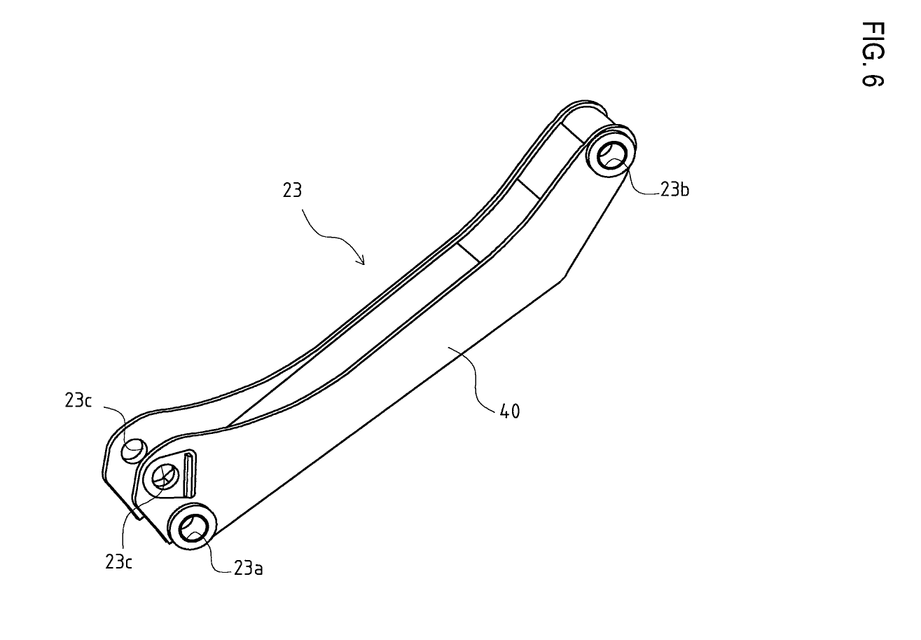

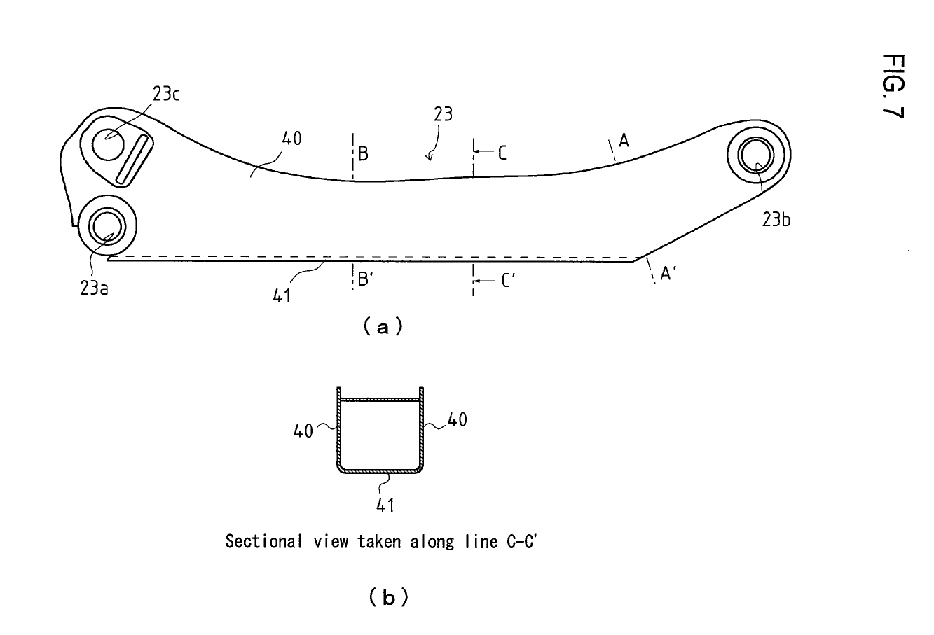

FIG. 1 is a side view showing an entire structure of a back hoe loader having a stabilizer of the present invention. FIG. 2(a) is a side view in a state where the stabilizer is turned upward, and FIG. 2(b) is a side view in a state where the stabilizer is projected sideway. FIG. 3 is a perspective view showing a shape of a stabilizer pad of the present invention. FIG. 4 is a perspective view showing a shape of a stabilizer pad according to another embodiment. FIG. 5 is a side view of the stabilizer pad. FIG. 6 is a perspective view showing a leg body structure of the stabilizer. FIG. 7(a) is a side view of the stabilizer and FIG. 7(b) is a sectional view of the stabilizer.

A work vehicle according to an embodiment of the present invention will be described with reference to FIG. 1. A work vehicle 1 shown in FIG. 1 is a back hoe loader, and a loader 2 and a drilling device 3 are mounted on the back hoe loader. The work vehicle 1 is provided at its central portion with a control section 4. The loader 2 is disposed in front of the control section 4, and the back hoe 3 is disposed behind the control section 4 as the drilling device. Front wheels 8, 8 and rear wheels 7, 7 are mounted on the work vehicle 1, and the work vehicle 1 can run in a state where the loader 2 and the back hoe 3 are mounted.

A steering wheel 5 and a seat 6 are disposed in the control section 4, a running operation device and an operation device of the loader 2 are disposed at a side of the seat 6. With this, in the control section 4, the steering operation of the work vehicle 1 and the operation of the loader 2 can be carried out.

The loader 2, which is a loading device, is connected to a side of the work vehicle 1 and extends forward, and a bucket 9 is mounted on a tip end of the loader 2.

The back hoe 3 is detachably attached to a rear portion of the work vehicle 1. The back hoe 3 is operated by an operation device disposed behind the cockpit 6.

The back hoe 3 includes a machine casing 13. The machine casing 13 is provided at its both left and right sides with stabilizers 10. A boom bracket 15 is mounted on a rear portion of the machine casing 13 such that the boom bracket 15 can turn laterally around a vertical shaft, and a base portion of the boom 16 is attached to the boom bracket 15 such that the base portion can turn laterally around a vertical shaft. A base portion of the arm 17 is attached to the tip end of the boom 16 such that it can turn laterally around a vertical shaft. A bucket 18 is mounted on the tip end of the arm 17 through a link mechanism such that the bucket 18 can rock. The boom bracket 15, the boom 16, the arm 17 and the bucket 18 can turn by extending and shrinking hydraulic cylinders.

The stabilizers 10 will be described with reference to FIG. 2. Since the stabilizers 10 are almost laterally symmetrically, only one of them will be described.

The stabilizers 10,10 each are disposed on both left and right sides of a mounting base portion of an operating machine (back hoe 3) of the work vehicle 1. The stabilizers 10 stretch against the ground to stabilize the machine body. The stabilizer 10 includes a bracket 22 fixed to a side surface of the machine casing 13, a leg body 23 mounted on an outer side lower portion of the bracket 22 such that its base portion can vertically turn around front and rear shafts, a vertically moving cylinder 24 mounted to a tip end upper portion of the leg body 23 and an outer side upper portion of the bracket 22 such that the vertically moving cylinder 24 can vertically turn around front and rear shafts, and a stabilizer pad 30 pivotally mounted on a tip end of the leg body 23. The stabilizer pad 30 is vertically turnably mounted on the tip end of the leg body 23 by a pivot shaft 26 which is disposed in the lateral direction and which functions as a fulcrum. The pivot shaft 26 is disposed below the pivoting portion (FIG. 2(b)) of an end of a cylinder tube of the vertically moving cylinder 24. A pivoting portion of a rod end of the vertically moving cylinder 24 with respect to the bracket 22 is located above the pivot shaft 27 which pivotally supports a base portion of the leg body 23. By extending and retracting the vertically moving cylinder 24, the stabilizer 10 can vertically move.

An embodiment of the stabilizer pad of the present invention will be described with reference to FIGS. 2 and 3.

FIGS. 2(a) and (b) show a state where the vertically turning stabilizer 10 is moved upward, and a state where the stabilizer 10 is projected sideway.

FIG. 3 is a perspective view of the stabilizer pad 30 according to the embodiment. The stabilizer pad 30 is formed into substantially “U” shape as viewed from above, and an outer side thereof is opened. Support stays 30a, 30a are integrally standing upward from left and right central portions of the stabilizer pad 30. Shaft holes 30b, 30b are formed upper and lower left and right central portions of the support stays 30a, 30a. A tip end of the leg body 23 is located between the support stays 30a, 30a, the leg body 23 is aligned with a shaft hole 23a (FIG. 6) formed in the tip end of the leg body 23 so that the leg body 23 can be pivotally supported around the pivot shaft 26. As shown in FIG. 5, projecting stoppers 30c, 30c upwardly project from an upper surface of a connecting portion located inside such as to connect the front and rear plates to each other.

Balancers 25, 25 are integrally formed at outer sides than the shaft hole 30b into which the pivot shaft 26 is inserted in the stabilizer pad 30. That is, the balancers 25 are steel mass weights, and integrally formed outer sides than the lateral center. More specifically, each balancer 25 integrally stands from an end of the ground-contact surface 30d and is formed into a rectangular parallelepiped, and is thicker than other ground-contact portions, and an upper periphery are chamfered. The balancers 25, 25 make it difficult for earth and sand to enter from the upper surface at the time of ground-contacting operation during operation. An upper surface of the balancer 25 is inclined such that the upper surface is lowered toward the outside so that earth and sand can easily fall. The balancer 25 may be fixed by means of a bolt or the like as a separate member or may be fitted, and if its weight is great, the balancer 25 may be disposed only one of front and rear portions, and a shape of the balancer 25 is not limited only if outside in the lateral direction of the stabilizer pad 30 is heavy.

The stabilizer pad 30 is pivotally supported on the tip end of the leg body 23 such that the stabilizer pad 30 can laterally rock around the longitudinal shaft by the pivot shaft 26, and the balancers 25, 25 are provided at outer sides of the stabilizer pad 30. With this structure, the ground-contact surface (bottom surface) 30d of the stabilizer pad 30 can always be directed downward. That is, in a state where the vertically moving cylinder 24 is retracted and the leg body 23 is upwardly turned and accommodated (FIG. 2(a)), the balancer 25 is located higher than the pivot shaft 26, but since the balancer 25 is located at outer side than the pivot shaft 26, the stabilizer pad 30 turns counterclockwise in FIG. 2, the stoppers 30c, 30c abut against the lower surface of the leg body 23 and the stabilized state can be maintained. Also when the vertically moving cylinder 24 is retracted and the stabilizer 10 is turned downward, since the balancers 25, 25 are located at outer sides than the pivot shaft 26, the outside of the stabilizer pad 30 is inclined downward, the turning motion is limited by the stopper 30c, and the ground-contact surface 30d does not turn to the vertical direction.

Therefore, even if the vertically moving cylinder 24 extends and retracts and the leg body 23 is vertically turned, a downward moment always acts on the stabilizer pad 30 around the pivot shaft 26 (direction of solid arrow α in the figure) by the weight of the balancer 25. As a result, the stabilizer pad 30 can always keep its attitude with its ground-contact surface facing downward irrespective of the vertical rotation of the leg body 23. When the leg body 23 is moved upward and turned and stopped at the upper limit end, the stabilizer pad 30 is not inversed toward the machine body by an inertial force, earth and sand are not accumulated on the stabilizer pad 30 by the inversion, the earth and sand does not fall on an operator, and the stabilizer pad 30 is not inverted upward by vibration and the like at the time of vertical turning motion.

In the actual use, when the ground at the time of operation is hard, the ground-contact surface 30d of the stabilizer pad 30 comes into contact with the ground, but when the ground at the time of operation is soft such as with mud, the ground-contact surface 30d comes into contact with the ground in a state where the stabilizer pad 30 is inverted in some cases. In such a case, if the stabilizer pad 30 is rotated upward and inverted, the balancers 25, 25 are located on inner sides of the machine body than the pivot shaft 26. In this state, the stabilizer pad 30 is kept such that the stabilizer pad 30 rotates in the opposite direction as that described above, and the inverted state can stably be maintained.

Next, another embodiment of the stabilizer pad 30 will be described with reference to FIGS. 4 and 5.

FIG. 4 is a perspective view showing that both side surfaces of the stabilizer pad 30 are provided with warps 35. FIG. 5 is a side view thereof.

The warps 35 prevent mud from being accumulated on the upper surface of the stabilizer pad 30 when the stabilizer pad 30 is in contact with the ground. The warps 35 obliquely abut against the ground surface due to the warps 35 when the stabilizer pad 30 moves and thus, a resistance can be reduced.

That is, the warps 35 can be provided around the ground-contact surface 30d. In this embodiment, the warps 35 are provided on end sides of front and rear outer sides. The warp 35 is formed by upwardly projecting a plate from front and rear end sides (front and rear side surfaces) of the ground-contact surface 30d. A cross section shape of a lower surface of the warp 35 may be flat or curved. The warp 35 may integrally fixed by means of welding or may be integrally formed on the stabilizer pad 30.

Since the warps 35 are provided on both front and rear sides of the stabilizer pad 30 in this manner, even if the stabilizers 10 project downward at the time of operation and the stabilizer pad 30 comes into contact with the ground and is engaged with the ground surface, earth and sand are pushed out outward by the warps 35, and earth and sand do not come onto the upper surface of the stabilizer pad 30. Hence, when the stabilizer 10 is moved upward and turned, and it is possible to prevent earth and sand accumulated on the stabilizer pad 30 from falling on an operator. Since an inner surface of the ground-contact surface 30d of a notch (inside of U-shape as viewed from above) of the stabilizer pad 30 is continuous with the support stay 30a, the inner surface does not come onto the upper surface of the stabilizer pad 30.

Next, the leg body 23 will be described with reference to FIGS. 6 and 7.

FIG. 6 is a perspective view of the leg body 23, which is a main structure of the stabilizer 10. FIG. 7(a) is a side view thereof and FIG. 7(b) is a sectional view thereof.

If the leg body 23 is a modification of a box-shaped structure, it is necessary to weld at four locations, i.e., a bottom plate, left and right side surfaces and a ceiling when the box-shape structure is formed using one sheet of plate. However, it is possible to reduce the number of welding steps and to form the box-shaped structure by using a channel member in which a bottom plate 41 and a side plate 40 are integrally formed together. Here, if the number of welding steps is reduced, the producing cost is reduced.

That is, each leg body 23 is extended in the longitudinal direction such that the bottom plate 41 is a vertical surface, and side plates 40, 40 are integrally extended in a direction intersecting with the bottom plate 41 at right angles on both sides of the bottom plate 41 in its short side direction. A channel member having substantially “U” shaped cross section is formed in this manner. A shaft hole 23a through which the pivot shaft 26 is inserted is formed in one end of the side plate 40, thereby forming a support boss, and a shaft hole 23c through which a pivot shaft 28 is inserted is formed. The pivot shaft 28 pivotally supports the vertically moving cylinder 24. A shaft hole 23b through which a pivot shaft 27 is inserted is formed in the other end of the side plate 40. The shaft hole 23b and the shaft hole 23a are disposed on an extension of a center line between the side plates 40 and 40.

Although the bottom plate 41 and the side plate 40 are shown as an integral channel here, the same effect can obviously be obtained even with a channel member in which a ceiling plate and the side plate are integral.

If the channel member in which the bottom plate 41 and the side plate 40 are integral is used, freedom degree of shape design can be obtained for the box shape.

In FIG. 7, a cross section shape (sectional view taken along the line A-A′) on the side of the shaft hole 23b and a cross section shape (sectional view taken along the line B-B′) on the side of the shaft hole 23a are different from each other, and the cross section shape (sectional view taken along the line A-A′) on the side of the shaft hole 23b is greater. That is, the cross section shape on the side of the shaft hole 23b which requires strength is made larger, thereby securing the strength.

In the case of a box shape having uniform cross section shapes, a cross section shape at a portion which requires the greatest strength is formed as an entire cross section shape, but in the case of a box shape having uneven cross section shapes, a cross section shape suitable for required strength in accordance with a location. This can prevent excessive quality design of members and reduce the weight.

### INDUSTRIAL APPLICABILITY

The present invention can be utilized for a stabilizer (outrigger) installed on a work vehicle to hold the stability of a vehicle body in excavating operation.

1. Stabilizers disposed on both left and right sides of a work vehicle to hold the stability of a vehicle body in operation by stretching both the left and right sides, wherein
each of the stabilizers comprises a leg body, a vertically moving cylinder for vertically turning the leg body, and a stabilizer pad being pivotally supported by a tip end of the leg body for coming into contact with the ground, and wherein a balancer is provided on an outer side than a pivot of the stabilizer pad.

2. The stabilizers according to claim 1, wherein the balancer and the stabilizer pad are integrally formed together.

3. The stabilizers according to claim 1, wherein warps are formed on ends of both side surfaces of the stabilizer pad.

4. The stabilizers according to claim 2, wherein warps are formed on ends of both side surfaces of the stabilizer pad.
